(19) United States
(12) Patent Application Publication
(10) Pub. No.: US 2005/0192817 A1
(43) Pub. Date: Sep. 1, 2005

(54) System and method for information handling system consumable automatic ordering

(76) Inventors: Dustin Sorenson, Austin, TX (US); Keith Hester, Austin, TX (US); Robert Rodgers, Leander, TX (US)

Correspondence Address: HAMILTON & TERRILE, LLP, P.O. BOX 203518, AUSTIN, TX, 78720, US

(21) Appl. No.: 10/787,399

(22) Filed: Feb. 26, 2004

(51) Int. Cl. G06F 17/60

(52) U.S. Cl. 705/1; 705/22; 705/26

(57) ABSTRACT

Information handling system consumable orders, such as orders for printer supplies, are placed through a network, such as the Internet, by automatically monitoring consumable quantity to detect a consumable order trigger event for presentation at the information handling system. User initiated selection of a consumable order communicates order information to a consumable order server, which pre-populates a completed order form for display at the information handling system, such as an order form with consumable information, payment information and delivery information. For instance, the consumable order server is associated with the manufacturer of the information handling system and applies the payment and delivery information from the purchase of the information handling system to complete the order form so that a user need only confirm the accuracy of the completed order form to place the consumable order.

### BACKGROUND OF THE INVENTION

1. Field of the Invention

The present invention relates in general to the field of information handling system consumables, and more particularly to a system and method for information handling system consumable automatic ordering.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems typically use one or more peripherals to manage, communicate or display information. For instance, information handling systems generally interface with external printers for printing information, such as documents written by word processing applications, presentations having graphics to explain or sell products, and multimedia pictures or photographs. Typically, the operating system of the information handling system includes a driver that manages the transfer of information to printed media. Often, networked information handling systems interface with a number of printers through a network that allows a user to select printing based on media, quantity and quality constraints. For instance, laser printers use toner from toner cartridges to print documents in color or black and white with high resolution in a relatively rapid manner. Ink jet printers use ink cartridges of various colors to print documents and photographs with high resolution but at a generally slower rate compared with laser printers. Thus, businesses tend to favor the more-expensive laser printers due to their high output rates while individuals tend to favor less-expensive ink jet printers due to their flexibility, particularly in the printing of photographs.

One difficulty faced by information handling system users is keeping the toner and ink of printers adequately supplied so that the availability of a printer is not lost while supplies are ordered. To aid in timely purchase of toner and ink, printer manufacturers sometimes include user interfaces that provide timely warnings of the need to order supplies and that point the user to a web site at which the user may purchase supplies. Although the timely warning is helpful, individual users are often hesitant to order through the Internet out of privacy concerns and the timeliness of the delivery of the supplies. Business users that have a number of networked printers often find the toner or ink low warnings to be of little value since business tend to maintain an inventory of supplies. In either case, ordering of supplies from the web sites identified by printer interfaces is often a frustrating experience that discourages users from making purchases. Generally, the user must navigate through a series of pages and input a significant amount of information, such as printer type, payment and delivery information. Consumers become less likely to successfully complete an order with each additional required entry due in part to the time and thought involved and in part to increased probability of a mistaken entry. Existing methods of filling information fields in web pages, such as the use of cookies to re-insert previously used information, do not offer sufficient security of private information, such as payment information. Businesses generally find it more convenient to maintain ink and toner stocks through services that periodically check and track printer supply consumption and inventory.

### SUMMARY OF THE INVENTION

Therefore a need has arisen for a system and method which automatically orders information handling system peripheral supplies with reduced consumer interactions.

In accordance with the present invention, a system and method are provided which substantially reduce the disadvantages and problems associated with previous methods and systems for ordering information handling system peripheral supplies. Upon detection of a trigger event for ordering a consumable at an information handling system, order information is sent through a network to a consumable order server for pre-population of a consumable order form. The consumable order form is completed and presented at the information handling system so that a user of the information handling system may confirm the consumable order without having to add information to the order form.

More specifically, a consumable handler on an information handling system communicates with a peripheral driver, such as a printer driver, to monitor consumable status. If a consumable trigger event is determined, such as a predetermined consumable level relative to a consumption rate, then order information is sent from the information handling system through the Internet to a consumable order server. An order engine applies the order information to select an appropriate order form for a consumable associated with the order information, and a pre-population engine pre-populates the consumable order form with payment and delivery information. The pre-populated order form is presented at the information handling system completed to support an order so that the user may simply confirm the order, or, update any inaccurate information and then submit the order. In one embodiment, multiple printers of multiple types are tracked with an accounting application so that the consumable order trigger event adjusts to manage an inventory of consumables for the printers of a complete business or business unit.

The present invention provides a number of important technical advantages. One example of an important technical advantage is that peripheral supplies, such as printer toner and ink, are ordered through a web site with minimal user interaction. Pre-population of the web page with printer supply order information, including ordered items, payment terms and delivery instructions, presents the user with an intuitive purchase decision that requires only confirmation of the order information by the user. Changes to the order information, if any, are made with minimal user interaction and, therefore, reduced risk of user error. Security of the user's private information is provided by the pre-population process, especially as compared with the use of readily accessible browser cookies to fill fields. Automated inventory management offers an integrated solution for complex networks having multiple printers to keep printer supply inventory to a desired level.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for information handling system printer consumable orders;

FIGS. 2A and 2B depict graphical user interfaces for supporting consumable ordering through a pre-populated order form;

FIG. 3 depicts a flow diagram of a process for information handling system consumable orders through pre-populated order forms; and

FIG. 4 depicts a flow diagram of a process for automated orders for consumables for plural printers aided by an accounting system module.

### DETAILED DESCRIPTION

Information handling system consumable orders are placed in a timely manner through a network with pre-populated order forms that reduce the user interactions needed to purchase the consumables. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

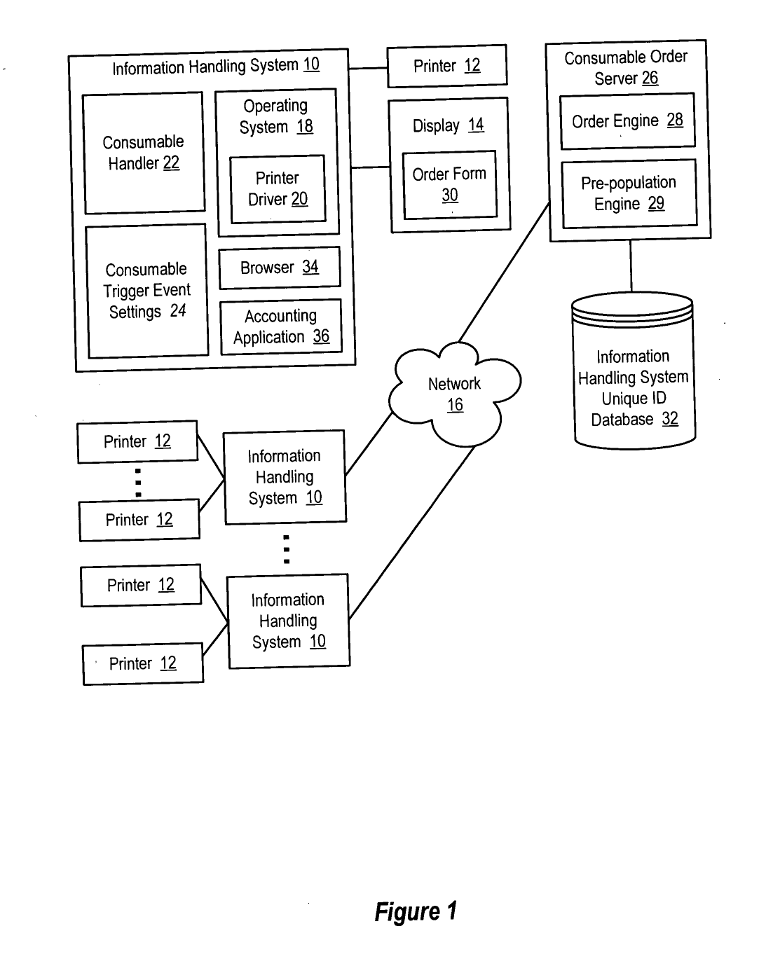

Referring now to FIG. 1, a block diagram depicts a system to automate orders of information handling system consumables by using pre-populated order forms. Plural information handling systems 10 have printers 12 and displays 14 and interface with a network 16, such as the Internet. Printers 12 include laser printers that write information with consumable laser toner cartridges and ink jet printers that write information with consumable ink jet cartridges. Each information handling system 10 has an operating system 18, such as Windows, that coordinates operation of processing components that process information, such as the CPU, memory, hard disc drive and communications ports. A printer driver 20 associated with operating system 18 manages communication of information with printer 12, including the transfer of processed information to printer 12 for printing and the transfer of management information from printer 12, such as ink or toner quantity levels and low level warnings.

A consumable handler 22 interfaces with printer driver 20 and monitors printer management information to detect a consumable order trigger event. For instance, consumable handler 22 tracks the toner or ink levels of printers 12, the time between toner and ink changes, and the number of pages printed or other indicia of daily or average use and usage patterns. The printer management information is applied against consumable trigger event settings to determine that a consumable order trigger event has occurred and, thus, to automatically initiate a consumable order. The consumable order trigger event is set so that a consumable order will be delivered before the printer becomes inoperative. Consumables include laser toner for laser printers, ink jet cartridges for ink jet printers, paper as a writing medium, including special photographic paper for printing pictures, and any other type of product consumed by usage at an information handling system. The occurrence of the trigger event is optionally presented at display 14 for confirmation by the information handling system user of the initiation of the automated consumable order process.

Consumable handler 22 initiates a consumable order for a consumable associated with the trigger event by sending order information through network 16 to a consumable order server 26. An order engine 28 applies the order information to identify consumables ordered and an associated order form. Order engine 28 provides the order form and order information to a pre-population engine 29 for pre-population of the order form with payment and delivery information and then communicates the completed order form 30 to consumable handler 22 for presentation at display 14. The user of information handling system 10 is able to review a completed order form and either confirm the pre-populated order form of correct only those items desired by the user. Confirmation of the order form is communicated by consumable handler 22 to order engine 28 for initiation of the delivery of the ordered consumable. Presentation of order form 30 may be supported through a browser 34 as a pop-up page or as an e-mail.

A primary concern in the automated ordering of consumables is the security of private information, such as payment and delivery information of consumers, so that unauthorized purchases do not occur. One way to accomplish security is to have consumers sign up for the service with delivery and payment information at the initial purchase of the information handling system or printer. In one such embodiment, the order information provided from consumable handler 22 includes a unique identifier, such as a service tag for the information handling system or printer, that pre-population engine 29 uses in a look-up of information handling system unique ID database 32 to find associated payment and delivery information. In an alternative embodiment, the payment and delivery information are stored locally on information handling system 10, such as at manufacture or by a user's signing up for a consumable order service. Consumable handler 22 sends the payment and delivery information as the order information in an encrypted packet for subsequent use by pre-population engine 29 in the pre-population of the order form. In yet another embodiment, portions of the functionality of pre-population engine 29 are included within consumable handler 22 so that a partially completed order form from order engine 28 has payment and delivery information included by consumable handler 22 at information handling system 10 for presentation at display 30. In situations involving businesses with plural networked printers, an accounting application 36, such as Quick Books, integrates with consumable handler 22 to track consumable inventory and usage for determining a consumable order trigger event appropriate to a desired inventory level.

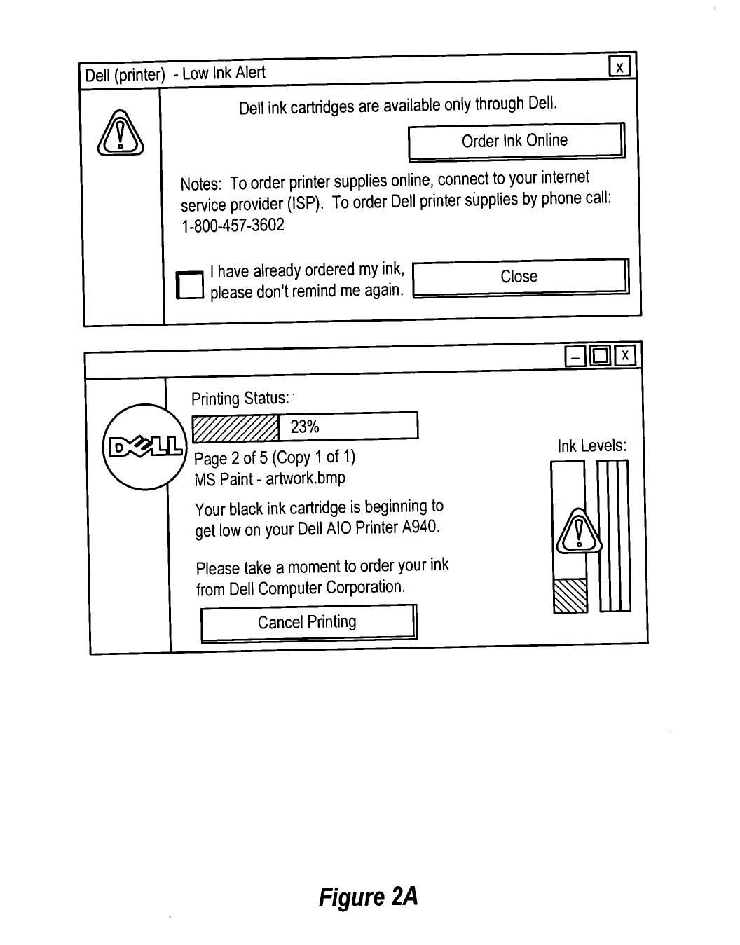

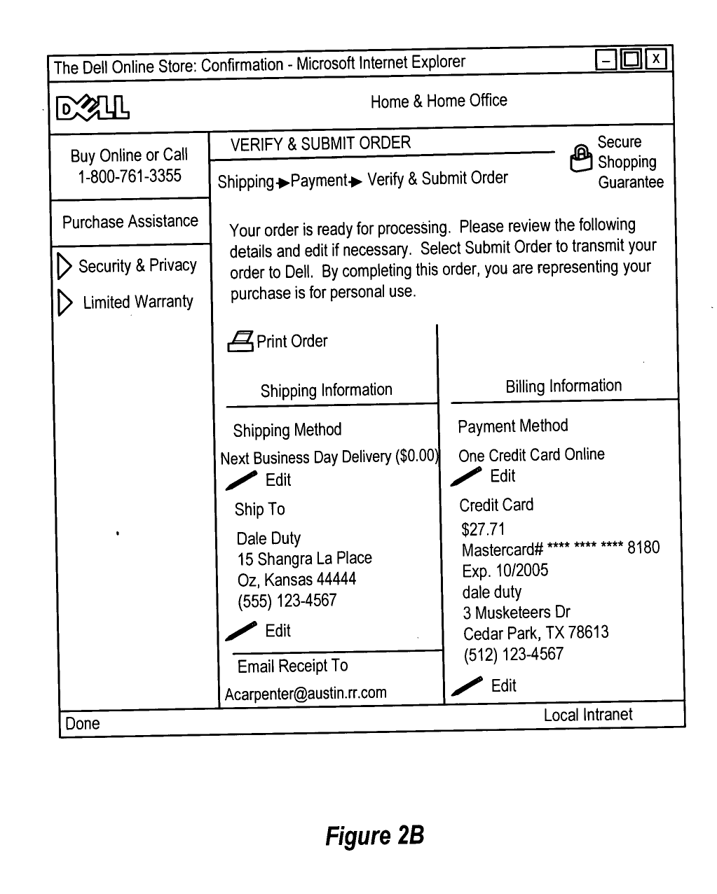

Referring now to FIG. 2A, an example of a graphical user interface is depicted to illustrate a notice to an information handling system user or a consumable order trigger event. For instance, the ink level and usage rate have reached a point at which an order for additional ink is needed to ensure delivery of the ink before the current supply runs out. The user initiates the order by selecting the “order ink online” button and is next presented with the graphical user interface depicted by FIG. 2B, which includes a completed order form. The fields of the order form include all of the information needed to submit an order for the consumable so that a user need only confirm the accuracy of the information, although each field is selectively correctable by the user should the user decide that changes are necessary.

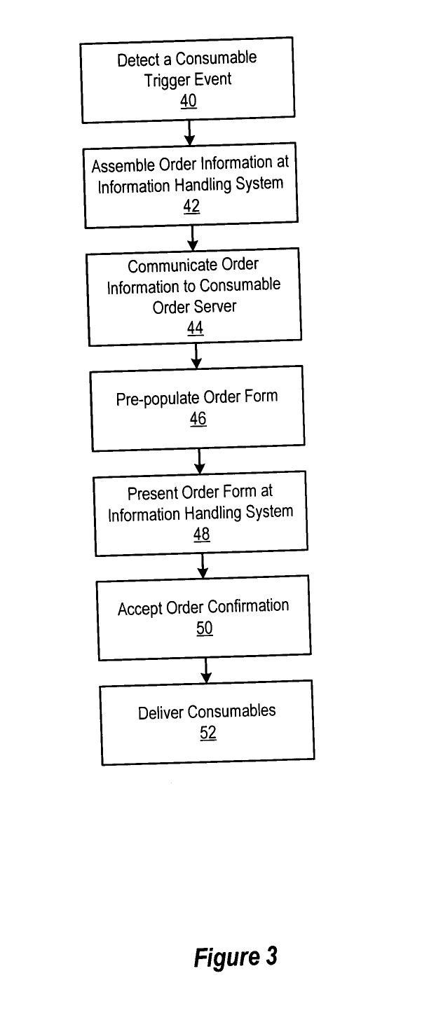

Referring now to FIG. 3, a flow diagram depicts a process for automated information handling system consumable ordering with a pre-populated order form. The process begins at step 40 with the detection of a consumable order trigger event. At step 42, order information is assembled at the information handling system, such as an identifier for the printer or information handling system or other locally stored quantity, payment and delivery preferences. At step 44, the order information is communicated to a consumable order server which identifies an appropriate consumable order form. At step 46, the order form is pre-populated with delivery and payment information, either at the order server or at the information handling system. At step 48, the completed order form is presented at the information handling system so that, at step 50, the user is able to accept the order confirmation with a single input. Once the user has accepted the consumable order, at step 52 the consumable is charged and delivered according to the payment and delivery instructions of the order form.

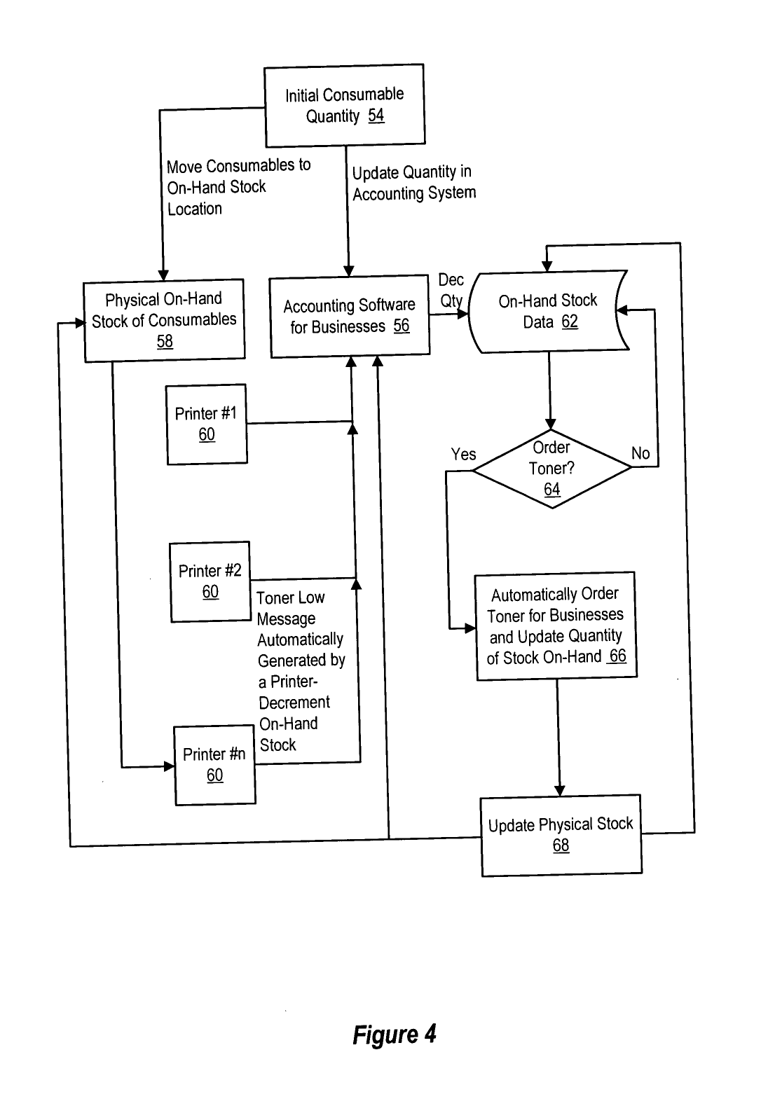

Referring now to FIG. 4, a flow diagram depicts an example of automated consumable ordering with a pre-populated order form in cooperation with an accounting application or module. The process begins at step 54 with an initial consumable quantity, such as is established by an initial purchase or an audit of existing supplies. Consumable supplies that can be tracked include any item consumed by printer usage, including customer replaceable units (CRUs) such as a laser imaging drum or belt, print head device (PHD), or fuser kit, or even field replaceable units FRUs that invoke an automated request for service. At step 56, the initial consumable quantity is applied to update the inventory count of an accounting application and, at step 58, the available inventory of consumables are made accessible for use. At step 60, a printer message relating to a consumable, such as a toner or ink low message, results in replacement of the consumable, such as with a new toner or ink, and a decrement to the inventory of the accounting application at step 56. Each decrement to the inventory results in a message to a consumable handler at step 62 that compares the on-hand stock with consumable trigger event settings at step 64 to determine if an order for toner or ink is desired. If not, the process returns to step 62 to await the next decrement. If yes, the process continues to step 66 for automatic ordering of consumables to obtain a desired inventory level. At step 68, the physical stock is updated upon delivery of the consumables. Advantageously, integration of automated consumable ordering with existing accounting applications, such as Quick Books, allows accurate tracking of consumables for multiple printers and multiple printer types and ease of management of payment information for the automatically ordered consumables.

Although the present invention has been described in detail, it should be understood that various changes, substitutions and alterations can be made hereto without departing from the spirit and scope of the invention as defined by the appended claims.

1. A system for managing orders through a network of consumables for an information handling system peripheral, the system comprising:
a consumable handler associated with the information handling system, the consumable handler operable to monitor the peripheral to detect a consumable trigger event and to assemble order information associated with the consumable trigger event in a predetermined format;
an order engine operable to present and accept an order form for the consumable through the network and at the information handling system; and
a pre-population engine interfaced with the consumable handler through the network and with the order engine, the pre-population engine operable to complete the order form for presentation to the information handling system in response to the order information.

2. The system of claim 1 wherein the peripheral comprises an ink jet printer and the consumable comprises one or more of ink or ink head device.

3. The system of claim 1 wherein the peripheral comprises a laser printer and the consumable comprises one or more of toner, imaging drum or imaging drum belt.

4. The system of claim 1 wherein the consumable handler comprises a module operable to interface with an accounting application and plural peripherals, the module tracking an inventory of consumables to place aggregate orders for consumables to supply the plural peripherals.

5. The system of claim 4 wherein the consumable handler module is further operable to automatically adjust the consumable inventory by decrementing the consumable supply at each consumable trigger event.

6. The system of claim 1 further comprising:
an information handling system database associated with the pre-population engine and having a unique identifier for each of plural information handling systems with payment and delivery information;
wherein the pre-population engine is further operable to complete the order form by populating the payment and delivery information of a unique identifier included with the order information.

7. The system of claim 6 wherein the order engine is further operable to accept updates to the order form entered at the information handling system.

8. The system of claim 6 wherein the order information comprises printer identification information, and wherein the pre-population engine is further operable to complete the order form with a consumable associated with the printer.

9. The system of claim 8 wherein the trigger event comprises one or more of consumable quantity, consumable consumption rate, time period between consumable orders, consumable usage patterns, consumable average daily use, or a user-selected parameter.

10. A method for managing orders through a network of consumables for an information handling system printer, the method comprising:
detecting a consumable trigger event associated with the peripheral;
assembling order information associated with the consumable trigger event in a predetermined format;
communicating the order information through the network to a consumable order server;
pre-populating an order form at the consumable order server in accordance with the order information;
presenting the order form through the network and at the information handling system;
accepting a confirmation of the order form at the information handling system; and
delivering the consumable in accordance with the order form.

11. The method of claim 10 wherein the printer comprises an ink jet printer and the consumable comprises ink.

12. The method of claim 11 wherein the consumable further comprises photographic printing paper.

13. The method of claim 10 wherein the printer comprises a laser printer and the consumable comprises toner.

14. The method of claim 10 wherein the order information comprises a unique identifier and pre-populating further comprises completing the order form in part with payment and delivery information stored at the order server.

15. The method of claim 14 wherein the payment and delivery information are the payment and delivery information used to purchase the information handling system.

16. The method of claim 10 wherein the trigger event comprises one or more of consumable quantity, consumable consumption rate, time period between consumable orders, consumable usage patterns, consumable average daily use, or a user-selected parameter.

17. The method of claim 10 wherein detecting a trigger event further comprises:
monitoring consumable inventory for plural printers with accounting software; and
determining a trigger event for the aggregate of printers and the consumable inventory.

18. An information handling system comprising:
plural components operable to process information for printing by a printer onto a medium;
a printer interfaced with the plural components to accept and print the information with a consumable;
an operating system operable to coordinate operation of the plural components;
a printer driver associated with the operating system, the printer driver operable to coordinate communication of the information to the printer and to detect available consumable quantity;
a consumable handler interfaced with the printer driver to accept detected consumable quantity, to apply the detected consumable quantity to determine a trigger event, to display the trigger event at the information handling system for user-selected initiation of a consumable order, and to communicate order information to a consumable order server upon user-selected initiation of a consumable order; and
a browser interfaced with the consumable handler and the consumable order server, the browser operable to display a consumable order form provided by the consumable order server, the consumable order form automatically completed to support user-selected confirmation of a consumable order.

19. The information handling system of claim 18 wherein the printer comprises a laser printer, the order information comprises a laser printer identifier, and the order form comprises a laser printer toner associated with the laser printer identifier and automatically selected by the order server.

20. The information handling system of claim 18 wherein the printer comprises an ink jet printer, the order information comprises an ink jet printer identifier, and the order form comprises an ink jet cartridge associated with the ink jet printer identifier and automatically selected by the order server.
